(19) United States
(12) Patent Application Publication
(10) Pub. No.: US 2014/0079865 A1
(43) Pub. Date: Mar. 20, 2014

(54) Process for Preparing a Stabilized Protein Suspension

(71) Applicant: CP Kelco ApS, Lille Skensved (DK)

(72) Inventors: Klaus Stegler Bjerrum, Kongens Lyngby (DK); Tina Benne Lohmann, Haslev (DK); Claus Rolin, Koege (DK)

(73) Assignee: CP Kelco ApS, Lille Skensved (DK)

(21) Appl. No.: 14/022,195

(22) Filed: Sep. 9, 2013

Related U.S. Application Data
(60) Provisional application No. 61/701,578, filed on Sep. 14, 2012.

(51) Int. Cl. A23C 9/154

(52) U.S. Cl. CPC A23C 9/1542
USPC 426/583; 426/271

(57) ABSTRACT

Processes are provided for preparing acidified milk drinks having improved stability. In an aspect, the process involves adding an aqueous stabilizer solution including an HM pectin and one or more sequestrants to an acidified milk product to produce the acidified milk drink. The one or more sequestrants desirably are present in the aqueous stabilizer solution in an amount that is stoichiometrically greater than the concentration of calcium ions present in the aqueous stabilizer solution, and are present in the acidified milk drink in an amount that is stoichiometrically less than the concentration of calcium ions in the acidified milk drink. The resulting acidified milk drink is characterized as a stable, optically opaque, drinkable product.

### RELATED APPLICATIONS

The present application claims the benefit of U.S. Provisional patent Application No. 61/701,578 filed on Sep. 14, 2012, the disclosure of which is incorporated herein by reference in its entirety.

### BACKGROUND

Pectin is a natural material that is abundantly present in plants, and is thus a major part of typical human diets. It can be isolated from appropriate plant material by aqueous extraction, and about 50,000 MT/year is commercially sold—mostly for use as an ingredient in industrially prepared food. Chemically described, pectin is a water-soluble mixture of macromolecules with distinctly different macromolecular parts that can occur in different amounts. The main component is polymerized anhydrogalacturonic acid that has some of its carboxyl groups esterified with methanol. The percentage of the carboxyl groups that are methyl esterified is termed the Degree of (Methyl) esterification (DM).

A diversity of pectin preparations is commercially available. Though all of them have the above-described properties of pectin, and normally comply with definitions and specifications stipulated by international and major national legislative organizations, there are different qualities desirable for different uses. The pectin properties depend upon the chosen botanical raw materials, and depend upon the operations and conditions used for isolating the pectin from the raw materials. Accordingly, differences can be observed between samples with respect to the pectin's functional behavior, such as, the pectin's solubility in water when other dissolved materials, like sugars, salts and acids, are present.

The functional characteristics of the different qualities of pectin can be scientifically rationalized as differences in the DM, the average size of the macromolecules, the pattern with which esterified and unesterified anhydrogalacturonic acid repeating units are arranged within the molecules, and the broadness in the statistical distribution of properties between the molecules. On the other hand, this rationalization of functional behavior is incomplete and limited by the current level of scientific understanding.

When in an aqueous solution, pectin has its best chemical stability at a pH of about 3.8. Stability is still fair at lower pH, at least until a pH of about 2.0. At a pH higher than about 4.5, on the other hand, the degree of polymerization of pectin gradually declines because the glycosidic linkages that connect the repeating units of the polymer backbone are broken by a reaction known as beta-elimination. While pectin generally is soluble in pure water, the solubility is reduced by the presence of materials that reduce the availability of water, for example water-miscible solvents or sugars, by low pH (to a moderate extent), and by the presence of divalent cations like Ca++ (to a greater extent). Thus, it generally is desirable that pectin be substantially free of divalent metal ions and that some (but not all) of its carboxyl groups be balanced by monovalent ions (like Na+).

Commercial pectin preparations are classified as either HM-pectin (High Methyl ester pectin) or LM-pectin (Low Methyl ester pectin) according to whether the DM is above or below 50. Some commercial pectins may further include amidation, acetate esterification, or both. Amidation is only significant in pectins that have been exposed to ammonia during manufacturing while acetate esterification occurs naturally in some raw materials from which pectin is extracted.

HM pectin has been used commercially to provide stability to acidified milk drinks (AMD). AMD are fluid products that contain milk proteins and possess some acidity. “Fluid”, as used herein, means that the product has properties more suitable to drinking than eating with a spoon. For example, drinkable yoghurt is one example of an AMD that is produced from natural milk by fermentation with a bacterial culture to attain a pH of typically less than 4.4. Although some fermented AMD products are sold with living cultures, others are heat-treated after fermentation in order to improve shelf life.

In natural milk that has not been acidified, protein exists as suspended bodies that are so small that they cannot be detected as individual bodies by ordinary vision, nor can the suspended protein bodies be distinguished from a homogenous liquid by the senses of the oral cavity. On the other hand, milk is white and opaque because the suspended protein bodies are large enough to disperse visible light. When fresh, the suspended protein bodies of the natural milk repel each other and do not aggregate into larger lumps. Upon lowering the pH, however, the suspended protein bodies lose their mutual repulsion and aggregate, which may result in a gel formed by a network of aggregated protein particles that is more characteristic of a yoghurt to be eaten with a spoon. Although yoghurt is reasonably stable during its normal shelf life, the signs of instability that may be observed, like a small or moderate amount of whey exudation, are common and generally accepted by consumers. In contrast, rupture of the curd to make a fluid product, such as an AMD, allows for the continued aggregation of protein particles and segregation of the product into two or more phases that are notably different and unappealing to consumers. Manufacturers have used HM pectin to address these issues with only limited success.

An HM pectin solution with a fairly high DM pectin is added by manufacturers to an AMD when the fermentation attains the desired acidity, stirs the ingredients thoroughly together, and then homogenizes the ingredients. The pectin is believed to adsorb to the sticky surface of the suspended protein bodies, binding at segments of the pectin molecule with locally high concentrations of negatively charged unesterified carboxyl groups. The other parts of the pectin molecule, which possess more affinity to the serum phase of the AMD, are believed to create a hydrated non-sticky layer that reduces the stickiness of the protein surface. Thus, HM pectin with a fairly high DM is believed to possess the appropriate balance between the segments that adsorb to acidified protein and the segments with affinity for the serum.

Although HM pectin provides some added stability to AMD, the HM pectin also may detrimentally affect the rheology of the AMD solution in the presence of calcium salts, either augmenting the viscosity of the solution, turning the solution into a gel, turning the solution into soft lumps that float in a thinner liquid, or precipitating the pectin. As the HM pectin used to stabilize AMD generally is especially calcium sensitive, and given the abundance of calcium ions in the AMD that are available for combining with pectin, reactions between the pectin and calcium ions reduce the efficacy of pectin, because either thickening or gelling makes it difficult to blend the ingredients uniformly or precipitating and aggregating of the pectin makes it unavailable to adsorb to the protein surfaces. The problem is evident even when the pectin is dissolved in pure de-ionized water prior to blending it with the AMD, and is worse if the pectin is dissolved in hard water. In the latter case, the pH of the pectin solution may become so high that it may damage the pectin.

Accordingly, there remains a need for abating reactions between pectin and calcium ions that prevent pectin added to AMD from being fully utilized.

### SUMMARY OF THE DESCRIPTION

In an embodiment, a process for preparing an acidified milk drink is provided including providing an acidified milk product comprising a fluid suspension of protein and dissolved calcium salts; preparing an aqueous stabilizer solution comprising an HM pectin and one or more sequestrants; and thereafter blending the aqueous stabilizer solution and the acidified milk product to provide an acidified milk drink. The acidified milk drink is characterized as a stable, optically opaque, drinkable product.

### BRIEF DESCRIPTION OF THE DRAWINGS

FIGS. 1A and 1B are graphs showing the average sediment (Y-axis) versus the pectin dosage (X-axis) for acidified milk drinks prepared without heat treatment (1A) and with heat treatment (1B).

### DETAILED DESCRIPTION

Embodiments of the present description address the above-described needs by providing an improved pectin-stabilized acidified milk drink (AMD). More particularly, the present description relates to AMD prepared using blends of pectins and one or more sequestrants and methods for preparing AMD using blends of pectin and one or more sequestrants.

The improved pectin-stabilized AMD are characterized as stable, optically opaque fluids comprising an acidified milk product, an HM pectin, and at least one sequestrant. The presence of the sequestrant in a pectin solution added to the acidified milk product significantly improves the stability of the final AMD and/or enables the milk-drink manufacturer to prepare an adequately stable AMD using smaller amounts of pectin than otherwise would have been possible, thereby providing significant cost savings.

Acidified Milk Product

The term “acidified milk drink,” as used herein, refers to any drinkable product based on acidified milk products, and generally can be divided into two categories: directly acidified milk drinks and fermented milk drinks The directly acidified milk drinks generally are acidified by using an acid and/or fruit concentrate to acidify a milk product. The fermented milk drinks, such as yogurt drinks, are acidified by fermenting the milk product with a microorganism, such as L. bulgaricus and S. thermophilus. Thus, AMD are drinkable products having a milk product and a pH lower than that of fresh milk, irrespective of the manner by which the pH has been reduced. For example, in embodiments the AMD may have a pH from about 3.0 to about 5.0 (e.g., from 3.3 to 4.6, from 3.3 to 4.3, from 3.7 to 4.3, from 3.7 to 4.6, or from 4.3 to 4.6).

“Milk product,” as used herein, includes milk based products that may comprise any suitable dairy milk product, non-limiting examples of which include a non-fat milk (e.g., skim milk), 2% fat content milk, whole milk, reconstituted dried or powdered milk, milk protein concentrates and/or isolates, and other forms of milk such as evaporated milk, condensed milk, and the like. The milk product also may comprise soy milk products (i.e., soy protein products), which may include soy milk protein concentrates and/or isolates, whole soy milk, and the like. The term “acidified milk product,” as used herein, refers to any milk-based product which has been acidified, including fermented milk products and acidified milk drinks

In its most basic form milk is a suspension of milk solids in a continuous aqueous phase. The milk solids include both a fats and a non-fats portion commonly referred to as milk solids non-fats (MSNF). The MSNF include proteins (such as whey proteins and casein) and carbohydrates, as well as trace components like organic acids and minerals and vitamins. The AMD desirably are prepared with a sufficient amount of milk product to provide the desired MSNF content. In embodiments, the AMD include a sufficient amount of milk product to provide a MSNF content from about 0.5 to about 20% (w/w). For example, the AMD may be prepared from a yoghurt made by fermenting a suspension of 17% (w/w) skimmed milk powder and 83% (w/w) water, such that the resulting yoghurt is said to contain 17% MSNF. Such products are known to those skilled in the art, and are described in more detail in U.S. Patent Publication No. 2007/0087103 and U.S. Patent Publication No. 2013/0034639, the relevant disclosures of which are incorporated herein by reference.

The AMD also may be prepared with a sufficient amount of acidified milk products to provide a desired protein content. For example, in one aspect the protein content of the AMD preferably is similar to that of natural milk products (e.g., about 3.4% in the case of bovine milk) or lower. In another aspect, the AMD is a protein-fortified product and includes protein in an amount from about 5 to about 10% (w/w).

Pectin

The pectins suitable for use in embodiments of the present description may comprise any pectin suitable for use in AMD capable of providing the desired protein stability without promoting gelation of the AMD. Desirably, the pectins comprise HM pectins with a DM of greater than about 50, greater than about 55, greater than about 60, greater than about 65, or greater than about 70. For example, in embodiments the HM pectin has a DM from about 55 to about 85, from about 57 to about 0, from about 59 to about 77, from about 65 to about 75, or about 70.

Those skilled in the art will appreciate that pectin manufacturers can, to some extent, control the DM of the pectin by appropriate processing steps and conditions. In one aspect, the HM pectin is a non-amidated pectin derived from a citrus peel, which is known to contain substantially no or only nominal amounts of acetate esterification. For example, in an embodiment the HM pectin comprises a pectin with a DM of about 70 that is derived from a citrus peel.

The HM pectin may be present in the AMD in any amount effective to impart the desired stability to the AMD. In embodiments, the HM pectin is present in the acidified milk drink in an amount from about 0.05% (w/w) to about 0.5% (w/w), from about 0.05% (w/w) to about 0.3% (w/w), or from about 0.05% (w/w) to about 0.2% (w/w).

Sequestrant

The one or more sequestrants may be selected from a variety of different calcium-stabilizing sequestrants, non-limiting examples of which include sodium hexa-meta phosphate, sodium pyrophosphate, and combinations thereof.

The sequestrant may be present in the AMD in any amount effective to impart the desired stability to the AMD. For example, in embodiments the amount of sequestrant in an aqueous pectin solution added to the acidified milk product is stoichiometrically greater than the amount of calcium ions present in the aqueous pectin solution, while the amount of sequestrant present in the AMD is stoichiometrically less than the amount of calcium ions present in the final drinkable product. For example, the sequestrant may be present in the aqueous pectin solution added to the acidified milk product in an amount from about 1% to about 20% (w/w) of the aqueous pectin solution, or from about 5% to about 20% (w/w), or from about 10% to about 20% (w/w), and present in the AMD in an amount from about 0.001% (w/w) to about 1.0% (w/w) of the AMD, from about 0.001% (w/w) to about 0.5% (w/w), from about 0.005% (w/w) to about 0.1% (w/w), or from about 0.01% to about 0.05% (w/w).

Methods of Manufacturing AMD

In another aspect, processes are provided for preparing a stable, optically opaque, AMD. The method generally comprises the steps of providing an acidified milk product comprising calcium salts and a fluid suspension of protein, preparing an aqueous solution comprising an HM pectin and one or more suitable sequestrants, and blending the aqueous solution and acidified milk product together to form an AMD. In one aspect, the step of preparing an aqueous solution comprising an HM pectin and one or more suitable sequestrants may comprise preparing a dry blend of the HM pectin and the one or more sequestrants, and subsequently dissolving the dry blend in an aqueous media (e.g., water). In another aspect, the step of preparing an aqueous solution comprising an HM pectin and one or more suitable sequestrants may comprise preparing a aqueous solution of the one or more sequestrants in an aqueous media and dissolving an HM pectin in the aqueous solution of the one or more sequestrants.

The presence of a sequestrant in a pectin solution added to an AMD significantly improves the stability of the final milk drink and/or enables the milk-drink manufacturer to prepare an adequately stable drink using a smaller amount of pectin than otherwise would have been possible (thereby providing cost savings). The presence of substantial amounts of calcium ions may suppress the solubility of pectin. Although it generally is known that sequestrants may bind calcium ions, many prior art references teach the desirability of using large quantities of sequestrant to obtain the desired result. In the embodiments provided herein, however, the sequestrant can effectively improve the performance of pectin even when it is present in a far smaller amount than the stoichiometric equivalent of the calcium ions in the AMD.

Moreover, the presence of a sequestrant in an aqueous pectin solution used to prepare an AMD can be beneficial when the aqueous pectin solution is prepared with soft water, which has fewer calcium ions than hard water. The beneficial results achieved when using a sequestrant with a pectin solution prepared using soft water is surprising because the (modest amount of) originally present calcium should have been able to bind only a minor part of the pectin carboxyl groups. Thus, it would not be expected to produce as substantial as an improvement. This suggests that the sequestrant function is more than the mere improvement of the solubility of pectin in the final drinkable product or the improvement of the solubility of the bulk part of the pectin in the aqueous solution. That is, in addition to these two functions, there also is a further and unexpected beneficial effect achieved by use of the sequestrant with a pectin solution.

Not wishing to be bound by any particular theory, the pectin in the absence of an added sequestrant may be poorly utilized for stabilizing the protein because it can form lumps in a fairly rapid reaction that takes place when the two liquids—the pectin solution and the protein suspension—come in contact for the first time. During the blending process, and while the blending is still incomplete, there can be temporary boundaries at which the concentration of pectin is much higher than it will become as an average for the final product. At the same time, the calcium coming from the calcium-containing protein suspension (i.e., yoghurt or the like) may be adequate for building gels with the pectin at the temporarily locally high concentration of pectin. Thus, lumps are formed. These lumps can also be described as gels of pectin, water and calcium ions. Even though this reaction is fast, it is not immediate, because the clumsy macromolecules need time to arrange themselves before they can combine with each other via calcium bridges. Thus, it is hypothesized that the presence of a sequestrant in the pectin solution prevents the existence of already formed pectin-calcium structures. Thereby, the rearrangement of molecules for combining with calcium takes so long that efficient shear of the preparation suffices for distributing the pectin evenly in the calcium rich milk (or protein suspension) before gels have time for building. In the absence of a sequestrant in the pectin solution, however, the building of pectin-calcium gel structures during the blending with milk propagates from gel structures that were already formed in the solution, and goes much faster.

Embodiments of the present description are further illustrated by the following examples, which are not to be construed in any way as imparting limitations upon the scope thereof. On the contrary, it is to be clearly understood that resort may be had to various other embodiments, modifications, and equivalents thereof which, after reading the description therein, may suggest themselves to those skilled in the art without departing from the spirit of the present invention and/or the scope of the appended claims. Unless otherwise specified, quantities referred to by percentages (%) are by weight (w/w %).

### EXAMPLES

The protocols, materials, and methods used in the experiments are summarized below.

Materials: Skimmed milk powder (Arla Milex 230 Instant Skimmed Milk Powder); Sodium polyphosphate, also known as Sodium Hexa-Meta Phosphate (SHMP), Gross formula=(NaPO3)n; n≈6. CAS-RN 10124-56-8. E452(i); Acidic sodium pyrophosphate, Gross formula=Na2H2P2O7. CAS-RN 7758-16-9. E450(i); Tap water containing about 21° dH (DK-4623 Lille Skensved municipality, Denmark).

Fermented milk product: Fermented milk product was prepared by fermenting a suspension of 17% (w/w) skimmed milk powder and 83% water to provide a yoghurt with 17% MSNF.

Sequestrant-Treated Pectin Samples: Pectin samples were prepared with SHMP during manufacturing of the pectin. The pectin was extracted from a citrus peel and processed until and including precipitation with alcohol. A 20% SHMP solution was prepared by adding 100 g SHMP powder to 400 mL de-ionized water and agitating until crystals were no longer be observed. A 60% 2-propanol solution was made by mixing the appropriate amounts of 2-propanol and de-ionized water. Solutions for treating the pectin were made by adding either 0 mL, 16.8 mL, 33.6 mL or 67.2 mL of the SHMP solution to 5 L of the 2-propanol solution. The squeezed alcohol-precipitated pectin (about 500 g of 16% dry material) was torn into smaller lumps and added to one of the pectin-treatment solutions. After about 3 minutes of gentle agitation, the liquid was drained away and the pectin sample was squeezed before being dried and milled.

Pectin Stock Solutions (with or without sequestrant): Appropriate amounts of pectin powder, sucrose, and optionally phosphate salt were weighed and blended. The powder blend was gradually dispersed in water (either tap water or de-ioniozed water to ensure for diverse experiments) while mixing with a Silverson type L4R. Moderate intensity was used from the beginning, and the intensity was gradually increased as more powder was added and the liquid became more viscous. After addition of all powder, and another 5 minutes of shearing, the mixer was removed. In those cases when it was desired, the pH was adjusted by addition of 50% citric acid solution (only reduction of pH has been relevant for the reported studies). The solution at this point weighed almost its desired final weight, or was otherwise adjusted by addition of appropriate amounts of water. The solution was carefully heated in a hot water bath to a temperature of 70 to 75° C. within 10 minutes, and was held for another 10 minutes. The solution was then cooled to 5° C. and was adjusted to the desired final weight by addition of water.

Stabilized Fermented Milk Drink: Desired amounts of yoghurt and sugar were combined and mixed for 2 minutes using a Silverson high-speed mixer to dissolve the sugar. During mixing, the mixture was maintained at a temperature of approximately 5° C. The pectin stock solution was diluted with varying amounts of de-ionized water and agitated with a magnetic stirrer to provide aqueous pectin solutions with different pectin concentrations for producing otherwise identical yoghurt drinks with different pectin dosages. For each aqueous pectin solution, the yoghurt-sugar mixture was dispensed into the aqueous pectin solution while stirring with a magnetic stirrer and until the new mixture was homogeneous (approximately 1 minute). Each of the yoghurt drinks was homogenized at 180-200 bars (within 1 hour). In certain cases where it was desired to simulate a heat-treated AMD, the yoghurt drinks were placed in a 75±2° C. water bath, making certain that 70° C. was reached within 10 minutes, and left for 20±1 minutes. The samples were transferred to the centrifugation tubes or viscosimeter glasses and analyzed.

Analysis of Viscosity: To measure viscosity, the samples were cooled in the viscosimeter glasses to 5° C. without stirring and the viscosity was measured using a Brookfield type LVT (60 RPM, 1 minute, spindle #1).

Analysis of Strength: Strength of the pectin was evaluated by preparing a series of otherwise identical AMD with different pectin concentrations, centrifuging the samples, quantifying the ensuing sediment, and then comparing curves of sediment as a function of pectin dosage. For each yoghurt drink, sediment was quantified twice by weighing about 10 g solution into each of two tared centrifugation tubes, centrifuging the tubes for 20 minutes at 4500 rpm (approx. 4400 g) and 20-25° C., decanting the supernatant, and placing the tubes upside down for 30 minutes to drain the remaining liquid. The rims of each tube were wiped off with filter paper and the tubes were weighed.

The fraction of sediment of the sample centrifuged was calculated as follows:

$$sediment = \frac{mass of tube with sediment - mass of empty tube}{mass of tube with sample - mass of empty tube} \times 100 \%$$

The average sediment (Y-axis) was plotted as compared to the pectin dosage (X-axis) and the samples were ranked by the sample's apparent strength as determined by the position of the sample's dosage-response curves in the XY-diagram. For example, a horizontal line was drawn from the Y-axis position (sediment) of the drink without pectin. The portion of the diagram below this line was referred to as “the lower part of the diagram”. In those instances where the two curves did not cross each other in the lower part of the diagram, the curve that appeared to the lower left represented the stronger pectin.

Analytical determination of SHMP in powder mixtures with pectin: SHMP-treated pectin samples were initially weighed and then wet-combusted (“destroyed”) using nitric acid and hydrogen peroxide as reagents and microwave as a heat source. Each solution ensuing from the “destruction” was transferred to a 50 mL volumetric flask, and 5.0 mL 2.5% CsCl solution was added before diluting to 50 mL. The liquids were then analyzed with an Inductively Coupled Plasma Atom Emission Spectrometer (ICP-AES).

The samples were passed through a nebulizer, spraying a mist of tiny drops of the solution into a carrying stream of argon. The current of carrier gas and the dispersed or evaporated materials of the solution were taken through “the torch”, i.e. a place in the path of the carrier gas at which the temperature was augmented by the energy of a radiofrequency generator so the materials entered the plasma state of matter. Under this condition, the elements emit each their characteristic wavelength of light. The spectral intensity at 213.613 nm wavelength was used to measure the phosphorus in the sample, and compared to a calibration reference sample.

### Example 1

### Yoghurt Drinks Stabilized with One Pectin Sample Present in a Range of Concentrations, Five Qualities of Water for the Pectin Solution, No Addition of Phosphate

Pectin solutions were prepared according to Table 1a and as described above. The following pectins were used for the experiments:
Pectin (PB44828/YM115LL) having a DM of 70.20, IV (intrinsic viscosity) of 6.0, CS99 (calcium sensitivity) of 255, and YOG3C (strength) of 188
Pectin (PP Trial 3 N5) having a DM of 67.52, IV of 6.23, CS99 of 668, and YOG3C of 169

CS99 is a metric used to characterized calcium sensitivity and is determined by the viscosity (in this case made using a Brookfield viscosmeter) of an aqueous solution of pectin and pH-buffering salts and a calcium salt. Higher values mean higher calcium sensitivity while the least calcium sensitive samples may be as low as about 10.

Commercial qualities of pectin are typically standardized to 115 grades YOG or 150 grades YOG by dilution with sucrose. The YOG grade is a metric for “strength”, i.e. for how little of the powder is needed to use for attaining some reference-degree of stability.

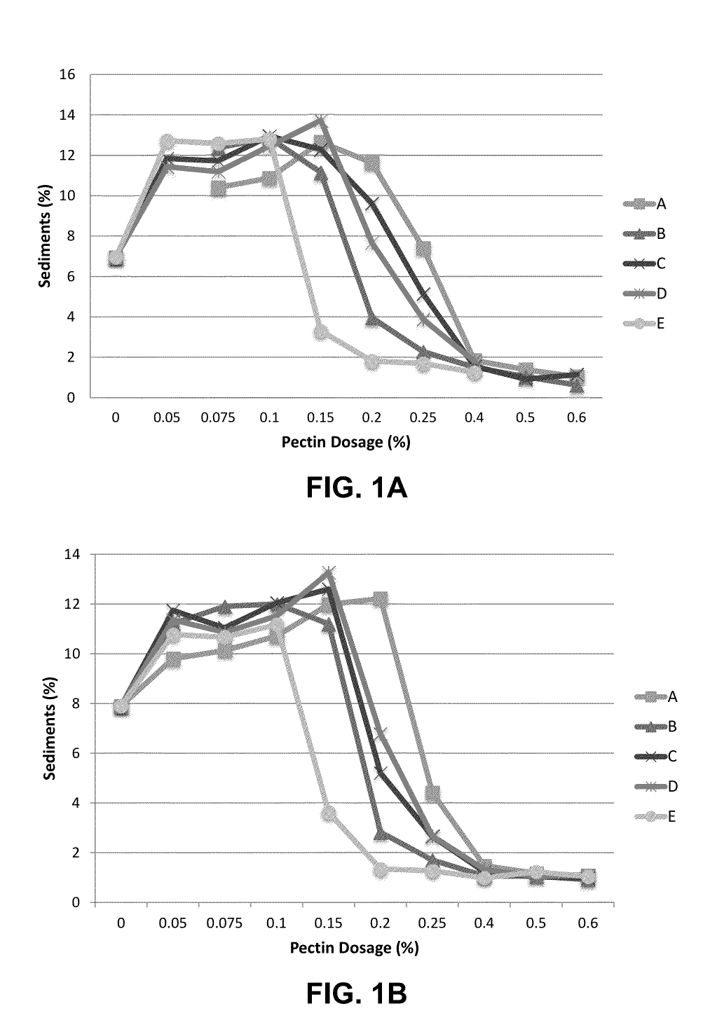

Prototype milk drinks with diverse concentrations of pectin were prepared by blending 17% MSNF yoghurt and a pectin solution according to Table 1b and as described above. After homogenization, each drink was split into two parts, with measurement of sediment by centrifugation being evaluated with or without heat-treating the drink. A summary of the sediments obtained is provided in Table 1c (without heat treatment) and Table 1d (with heat treatment) and illustrated in FIGS. 1A and 1B, respectively.

TABLE 1a

| Solution | | pH |
|---|---|---|
| name | Composition | (25° C.) |
| A | 1% pectin solution in tap water | 7.06 |
| B | 1% pectin solution in ½ tap water and ½ | 4.92 |
| | deionized water | |
| C | 1% pectin solution in tap water, pH adjusted | 4.23 |
| | with citric acid | |
| D | 2% pectin solution in tap water | 4.50 |
| E | 1% pectin solution in deionized water | 3.80 |

TABLE 1b

| Deionized | | Sugar | 17% MSNF | Total | Pectin |
|---|---|---|---|---|---|
| water (g) | | (g) | yoghurt (g) | (g) | dosage (%) |
| | 1% pectin | | | | |
| | solution (g) | | | | |
| 598.7 | 0 | 60 | 141.3 | 800 | 0.000 |
| 558.7 | 40 | 60 | 141.3 | 800 | 0.050 |
| 538.7 | 60 | 60 | 141.3 | 800 | 0.075 |
| 518.7 | 80 | 60 | 141.3 | 800 | 0.100 |
| 478.7 | 120 | 60 | 141.3 | 800 | 0.150 |
| 438.7 | 160 | 60 | 141.3 | 800 | 0.200 |
| 398.7 | 200 | 60 | 141.3 | 800 | 0.250 |
| 278.7 | 320 | 60 | 141.3 | 800 | 0.400 |
| 198.7 | 400 | 60 | 141.3 | 800 | 0.500 |
| 118.7 | 480 | 60 | 141.3 | 800 | 0.600 |
| | 2% pectin | | | | |
| | solution (g) | | | | |
| 598.7 | 0 | 60 | 141.3 | 800 | 0.000 |
| 578.7 | 20 | 60 | 141.3 | 800 | 0.050 |
| 568.7 | 30 | 60 | 141.3 | 800 | 0.075 |
| 558.7 | 40 | 60 | 141.3 | 800 | 0.100 |
| 538.7 | 60 | 60 | 141.3 | 800 | 0.150 |
| 518.7 | 80 | 60 | 141.3 | 800 | 0.200 |
| 498.7 | 100 | 60 | 141.3 | 800 | 0.250 |
| 438.7 | 160 | 60 | 141.3 | 800 | 0.400 |
| 398.7 | 200 | 60 | 141.3 | 800 | 0.500 |
| 358.7 | 240 | 60 | 141.3 | 800 | 0.600 |

TABLE 1c

| | Sediments (%) | | | | |
|---|---|---|---|---|---|
| Pectin dosage (%) | A | B | C | D | E |
| 0.000 | 6.95 | 6.95 | 6.95 | 6.95 | 6.95 |
| 0.050 | | | 11.84 | 11.43 | 12.72 |
| 0.075 | 10.40 | 12.37 | 11.72 | 11.19 | 12.58 |
| 0.100 | 10.87 | 12.86 | 12.95 | 12.46 | 12.80 |
| 0.150 | 12.66 | 11.15 | 12.28 | 13.72 | 3.30 |
| 0.200 | 11.62 | 3.95 | 9.61 | 7.67 | 1.81 |
| 0.250 | 7.40 | 2.27 | 5.13 | 3.87 | 1.69 |
| 0.400 | 1.84 | 1.50 | 1.55 | 1.80 | 1.25 |
| 0.500 | 1.38 | 1.03 | 0.91 | | |
| 0.600 | 1.03 | 0.62 | 1.14 | | |

TABLE 1d

| | Sediments (%) | | | | |
|---|---|---|---|---|---|
| Pectin dosage (%) | A | B | C | D | E |
| 0.000 | 7.90 | 7.90 | 7.90 | 7.90 | 7.90 |
| 0.050 | 9.80 | 11.21 | 11.74 | 11.36 | 10.77 |
| 0.075 | 10.13 | 11.91 | 11.04 | 10.86 | 10.67 |
| 0.100 | 10.71 | 12.00 | 12.05 | 11.52 | 11.17 |
| 0.150 | 11.98 | 11.20 | 12.60 | 13.27 | 3.61 |
| 0.200 | 12.22 | 2.82 | 5.20 | 6.78 | 1.34 |
| 0.250 | 4.41 | 1.70 | 2.65 | 2.67 | 1.27 |
| 0.400 | 1.47 | 1.06 | 1.23 | 1.32 | 0.98 |
| 0.500 | 1.17 | 1.05 | 1.03 | 1.04 | 1.23 |
| 0.600 | 1.08 | 0.91 | 0.97 | 1.09 | 1.03 |

The general shape of the curves was very similar to analogous curves published in the prior art. Going from zero dosage, with increasing pectin dosage, the weight of the sediment initially increased, while at higher dosages the weight of the sediment passed a maximum and then decreased with the dosage. To the right side of their maximum, all curves showed a decline that leveled off and became almost horizontal at the highest pectin dosages. The curves normally declined rather sharply after attaining their maximum until reaching the same sediment weight as the drink without stabilizer. The part of a diagram representing sediment values lower than that of the drinks without stabilizer is referred to as “the lower part of the diagram”. In those cases where the curves do not cross each other in the lower part of the diagram, it is unambiguous that a curve that appears to the lower left side of another curve represents a stronger pectin sample than that represented by said other curve. A “stronger” pectin sample means a sample with which one can use less pectin to attain a given level of stability, here measured as a low amount of sediment—the lower, the better.

In the present example, since the curves do not cross in the lower part of the diagram, the strength of the pectins can be unambiguously ranked as E (De-ionized water)>B (½ deioniz water, ½ tap water)>D (2% solution in tap water)>C (1% pectin in tap water, acidified with citric acid)>A (1% pectin in tap water). Almost the same ranking of strength was observed for heat treated drinks E>B>D≈C>A. The results appear to be the result of a combination of two different properties.

One of these effects relates to the pH of the pectin solution. The dissolved materials present in tap water possess a pH-buffering capacity that pulls the pH upwards. A high pH will result from dilute solutions of pectin, in particular pectin of high DM. The lower pH will result with solutions of concentrated solutions of pectin and with pectin that has a lower DM, because the pectin possesses a buffering capacity that stems from its non-esterified carboxylic acid groups. The high pH causes degradation of pectin, becoming noticeable at a pH above about 4.5 and gradually worsening at a higher pH. The extent of degradation depends upon the temperature during the pectin's exposure to this pH (increasing at elevated temperatures) and the duration of the exposure. The results of series C and D as compared to series A may be explained by this pH effect.

The other effect relates to the propensity of calcium ions for reducing the solubility of pectin. Tap water contains calcium salts that under the condition are dissociated so that the calcium exists as Ca++ ions; these ions are taken up by pectin for building pectin-calcium-pectin associations. The fermented milk contains an even larger amount of dissociated calcium compounds. Not wishing to be bound by any theory, it is believed that when a pectin solution that already contains associations between pectin and Ca++ meets with a Ca++-rich fermented milk, it becomes difficult to mix the two liquids together because of the formation of lumps. That Ca++ from tap water hampered the full utilization of pectin is evidenced by the results, with series E (ion exchanged water) faring much better than series C (tap water and pH adjustment)—even though the pH of 4.23 of the pectin solution for series C should not be adverse—and series B (½ deionized, ½ tap) faring better than series C and D—even though its pH of 4.92 should be more harmful than the pH of 4.23 and 4.50 of series C and D, respectively.

### Example 2

### Preparation of Yoghurt Drinks Stabilized with Two Pectin Samples Present in a Range of Concentrations, Two Qualities of Water Used for the Pectin-Solutions, and Three Levels of Phosphate Dosing (One of Which Being No Addition) for These Solutions

Pectin solutions were prepared according to Table 2a and as described above. Prototype milk drinks with diverse concentrations of pectin were prepared by blending 17% MSNF yoghurt and the pectin solution according to Table 2b and as described above. After homogenization, each drink was split into two parts, with measurement of sediment by centrifugation being evaluated with or without heat-treating the drink. A summary of the sediments obtained is provided in Table 2c (without heat treatment) and Table 2d (with heat treatment).

TABLE 2a

| Solution Name | Pectin type | Water type | SHMP (%) | pH (25° C.) |
|---|---|---|---|---|
| A | YM 115 L | deionized | 0 | 3.88 |
| B | YM 115 L | deionized | 20 | 3.97 |
| C | YM 115 LL | deionized | 10 | 3.56 |
| D | YM 115 LL | deionized | 20 | 3.61 |
| E | YM 115 LL | tap | 10 | 5.97 |
| F | YM 115 LL | tap | 20 | 6.01 |

TABLE 2b

| Deionized | 1% pectin | Sugar | 17% MSNF | Total | Pectin |
|---|---|---|---|---|---|
| water (g) | solution (g) | (g) | yoghurt (g) | (g) | dosage (%) |
| 449 | 0 | 45 | 106 | 600 | 0.000 |
| 419 | 30 | 45 | 106 | 600 | 0.050 |
| 404 | 45 | 45 | 106 | 600 | 0.075 |
| 389 | 60 | 45 | 106 | 600 | 0.100 |
| 359 | 90 | 45 | 106 | 600 | 0.150 |
| 329 | 120 | 45 | 106 | 600 | 0.200 |
| 299 | 150 | 45 | 106 | 600 | 0.250 |
| 269 | 180 | 45 | 106 | 600 | 0.300 |
| 209 | 240 | 45 | 106 | 600 | 0.400 |
| 149 | 300 | 45 | 106 | 600 | 0.500 |

TABLE 2c

| | Sediments (%) | | | | | |
|---|---|---|---|---|---|---|
| Pectin dosage (%) | A | B | C | D | E | F |
| 0.000 | 7.47 | 7.47 | 7.47 | 7.47 | 7.47 | 7.47 |
| 0.050 | 10.66 | 10.21 | 10.82 | 10.82 | 11.06 | 10.17 |
| 0.075 | 11.95 | 12.13 | 11.32 | 6.17 | 11.70 | 10.63 |
| 0.100 | 12.67 | 2.51 | 2.49 | 1.75 | 4.12 | 2.26 |
| 0.150 | 3.29 | 1.67 | 1.60 | 1.26 | 1.60 | 1.56 |
| 0.200 | 1.87 | 1.28 | 1.39 | 1.23 | 1.25 | 1.28 |
| 0.250 | 1.55 | 1.04 | 1.29 | 1.09 | 1.44 | 1.21 |
| 0.300 | 1.12 | 0.89 | 0.74 | 1.02 | 1.32 | 1.00 |
| 0.400 | 0.90 | 1.03 | 0.98 | 1.24 | 1.24 | 1.07 |
| 0.500 | 0.91 | 0.91 | 0.59 | 0.81 | 0.99 | 0.74 |

TABLE 2d

| | Sediments (%) | | | | | |
|---|---|---|---|---|---|---|
| Pectin dosage (%) | A | B | C | D | E | F |
| 0.000 | 9.80 | 9.80 | 9.80 | 9.80 | 9.80 | 9.80 |
| 0.050 | 11.92 | 10.97 | 11.21 | 8.97 | 8.98 | 8.30 |
| 0.075 | 11.93 | 11.48 | 12.35 | 9.70 | 9.91 | 9.21 |
| 0.100 | 12.57 | 10.96 | 7.67 | 2.50 | 10.00 | 2.43 |
| 0.150 | 4.00 | 1.47 | 1.26 | 0.87 | 1.53 | 1.46 |
| 0.200 | 1.49 | 1.42 | 1.35 | 1.16 | 1.19 | 1.09 |
| 0.250 | 1.40 | 1.27 | 1.16 | 0.96 | 1.21 | 1.15 |
| 0.300 | 0.98 | 1.05 | 1.02 | 1.10 | 1.02 | 1.01 |
| 0.400 | 1.25 | 0.92 | 0.86 | 0.83 | 1.00 | 0.99 |
| 0.500 | 0.94 | 0.82 | 0.94 | 1.18 | 0.80 | 0.83 |

The addition of SHMP to the pectin solutions was beneficial, even when de-ionized water was used for the solutions. For example, the pectin appeared stronger when combined with 20% SHMP, which was better than pectin combined with 10% SHMP.

Additionally, the addition of SHMP to the pectin solutions reduced the damaging effect of tap water observed in Example 1. For example, the YM-115-LL pectin dissolved in de-ionized water with SHMP or tap-water with SHMP performed almost similarly, with 20% SHMP performing slightly better than 10% SHMP. In contrast, in Example 1, samples dissolved in de-ionized water in the absence of SHMP appeared much stronger than samples dissolved in tap water (Table 1). Because the samples YM-115-L and YM-115-LL seemed slightly different in strength, no comparison of samples was made for pectin in de-ionized water without SHMP and pectin in tap water with SHMP for the same sample.

The relationship between SHMP and Ca++ may be further understood by stoichiometric calculations of the balance between SHMP and the amounts of Ca++ that are available in tap water and the milk drink, respectively.

SHMP has a molecular weight of 611.77. Under the conditions of the present examples (pH>3.5), one mole of SHMP may take up three moles of calcium ions to become Ca3P6018. The tap-water used had 21° dH corresponding to 210 mg CaO per liter (3.74 mmol/L). The equivalence of the calcium ion content of tap water thus was 1.25 mmol/L SHMP (764 mg/L). The pectin/tap-water solutions were with 1% pectin blends, out of which either 10% or 20% was SHMP. This, in turn, means that there were either 1000 or 2000 mg/L of SHMP in the pectin/tap-water solutions. Natural bovine milk, which roughly compositionally corresponds to a suspension of 8.5% skimmed milk powder, contains 1200 ppm Ca++. The milk drinks of Table 2b contained 3% skimmed milk powder, and thus 424 ppm Ca++ (10.6 mmoles/kg). With the maximum dosage of pectin in Tables 2c and 2d, viz. 0.5% pectin blend, the maximum dosage of SHMP to the milk drink would be 0.1%=1000 mg/kg≈1.63 mmoles/kg which may bind up to 4.90 mmoles/kg of Ca++.

Thus, the smallest tested dosage (10%) of SHMP just over-balances the Ca++ of the tap-water solutions. SHMP added was 1000 mg/L, balance of Ca++ was 764 mg/L. The largest tested presence of SHMP under-compensates the Ca++ of the milk drink: present Ca++ was 10.6 mmoles/L, while the maximum SHMP dosage can bind 4.90 moles/L. Thus, the beneficial effects of SHMP appear to be exercised either in the aqueous pectin solution prior to contacting it with the yoghurt, or during the blending of pectin solution and yoghurt.

### Example 3

### Four Levels of Phosphate (One of Which Being No Addition) Used for Pectin Solutions with Tap-Water. Phosphate Added During Pectin Manufacturing

Pectin samples with SHMP were prepared as explained described above to produce four samples: A (SHMP=0% w/w), B (SHMP=5.1% w/w), C (SHMP=9.8% w/w), and D (SHMP=18.15% w/w). Solutions of pectin samples A, B, C, and D were prepared according to Table 3a and otherwise as described above. Prototype milk drinks with diverse concentrations of pectin were prepared by blending 17% MSNF yoghurt and pectin solution according to Table 3b and as described above. After homogenization, each drink was split into two parts, with measurement of sediment by centrifugation being evaluated with or without heat-treating the drink. A summary of the sediments obtained is provided in Table 3c (without heat treatment) and Table 3d (with heat treatment).

TABLE 3a

| | | | | | | Calculated | | |
|---|---|---|---|---|---|---|---|---|
| | Amount of | | | Phosphate | Calcuated | true pectin | | % |
| | dried | Amount | | (% of | SHMP in | gum in | | saturation |
| | Phosphate- | of | | dried | final | final | pH of | of Ca++ |
| Solution | washed | sucrose | Total | phosphate- | solution | solution | final | in tap |
| name | Pectin (g) | (g) | (g) | washed) | (g/L) | (g/L) | solution | water |
| A | 8.650 | 4.350 | 13.000 | 0.00 | 0.00 | 8.65 | 4.04 | 0 |
| B | 9.090 | 3.914 | 13.004 | 5.10 | 0.46 | 8.63 | 4.25 | 61 |
| C | 9.490 | 3.508 | 12.998 | 9.80 | 0.93 | 8.56 | 4.25 | 122 |
| D | 10.210 | 2.786 | 12.996 | 18.15 | 1.85 | 8.36 | 4.35 | 243 |

(stoichiometric saturation of calcium in tap water: assume 21 dH = 3.74 mmol Ca++/L = 764 mg SHMP/L)

TABLE 3b

| Deionized | 1% pectin | Sugar | 17% MSNF | Total | Pectin dosage |
|---|---|---|---|---|---|
| water (g) | solution (g) | (g) | yoghurt (g) | (g) | (%) |
| 449 | 0 | 45 | 106 | 600 | 0.000 |
| 419 | 30 | 45 | 106 | 600 | 0.050 |
| 404 | 45 | 45 | 106 | 600 | 0.075 |
| 389 | 60 | 45 | 106 | 600 | 0.100 |
| 359 | 90 | 45 | 106 | 600 | 0.150 |
| 329 | 120 | 45 | 106 | 600 | 0.200 |
| 299 | 150 | 45 | 106 | 600 | 0.250 |
| 269 | 180 | 45 | 106 | 600 | 0.300 |
| 209 | 240 | 45 | 106 | 600 | 0.400 |
| 149 | 300 | 45 | 106 | 600 | 0.500 |

TABLE 3c

Sediments (%)

| Pectin dosage (%) | A | B | C | D |
|---|---|---|---|---|
| 0.000 | 7.24 | 7.24 | 7.24 | 7.24 |
| 0.050 | 10.00 | 9.82 | 9.90 | 10.51 |
| 0.075 | 11.12 | 11.11 | 11.80 | 8.38 |
| 0.100 | 9.32 | 9.01 | 4.75 | 1.94 |
| 0.150 | 3.14 | 2.16 | 1.83 | 1.51 |
| 0.200 | 1.88 | 1.57 | 1.82 | 1.60 |
| 0.250 | 1.71 | 1.03 | 1.24 | 1.61 |
| 0.300 | 1.06 | 1.45 | 1.03 | 1.08 |
| 0.400 | 0.68 | 0.67 | 1.01 | 0.92 |
| 0.500 | 1.10 | 1.24 | 1.40 | 1.28 |

TABLE 3d

Sediments (%)

| Pectin dosage (%) | A | B | C | D |
|---|---|---|---|---|
| 0.000 | 10.24 | 10.24 | 10.24 | 10.24 |
| 0.050 | 10.87 | 11.01 | 7.71 | 8.05 |
| 0.075 | 11.62 | 11.57 | 8.06 | 9.08 |
| 0.100 | 9.56 | 10.15 | 6.58 | 2.04 |
| 0.150 | 2.72 | 1.67 | 1.50 | 1.41 |
| 0.200 | 1.47 | 1.25 | 1.65 | 1.26 |
| 0.250 | 1.10 | 1.10 | 1.03 | 1.41 |
| 0.300 | 1.06 | 1.23 | 1.25 | 1.35 |
| 0.400 | 1.42 | 1.39 | 1.21 | 1.32 |
| 0.500 | 1.14 | 1.51 | 1.50 | 1.62 |

The same ranking of the sample strength was observed both with and without heat treatment, with D>C>B≈A. According to Table 3a, both A and B contained less SHMP than the stoichiometric balance of the Ca++ of the tap-water pectin solution, while C and D both contained more SHMP than the stoichiometric equivalent. Thus, further addition of SHMP may be beneficial even beyond stoichiometric saturation of the calcium ions of the tap-water pectin solution

### Example 4

### Three Levels of Phosphate (One of Which Being No Addition) Used for Pectin Solutions with De-Ionized Water. Point of Adding Phosphate, (a) During Pectin Manufacturing, or (b) to the Powder Blend

Pectin solutions with and without SHMP were prepared with de-ionized water according to Table 4a and otherwise in accordance with the protocol “Preparation of pectin stock solutions with or without sequestrant”. Prototype milk drinks with diverse concentrations of pectin were prepared by blending 17% MSNF yoghurt and pectin solution according to Table 4b and as described above. A summary of the sediments measured is provided in Table 4c. The viscosities of the same drinks are provided in Table 4d.

TABLE 4a-1

| | | | | | | Pectin powder | |
|---|---|---|---|---|---|---|---|
| | | Weighed out | | | | SHMP | Estimated |
| Solution | | Pectin | SHMP | Sugar | Total | content | Grade of |
| Name | Description | (g) | (g) | (g) | (g) | (% w/w) | Pectin |
| A | 1% pectin solution in de- | 13 | 0 | 0 | 13 | 0 | 100 |
| | ionized water | | | | | | |
| B | Pectin with SHMP added | 7.22 | 0.72 | 5.07 | 13.01 | 0 | 180 |
| | at solution preparation, | | | | | | |
| | medium dosage | | | | | | |
| C | Pectin with SHMP added | 7.22 | 1.26 | 4.53 | 13.01 | 0 | 180 |
| | at solution preparation, | | | | | | |
| | high dosage | | | | | | |
| D | Pectin with SHMP added | 7.93 | 0 | 5.07 | 13 | 9.92 | 180 |
| | during manufacturing, | | | | | | |
| | medium dosage | | | | | | |
| E | Pectin with SHMP added | 8.47 | 0 | 4.53 | 13 | 17.45 | 180 |
| | during manufacturing, | | | | | | |
| | high dosage | | | | | | |

TABLE 4a-2

| | | Pectin Solutions | | | | |
|---|---|---|---|---|---|---|
| | | | Pectin | | | |
| | | Pectin, Calculated | w/o | | | |
| Solution | | Grade 100 | SHMP | SHMP | pH | Viscosity |
| Name | Description | Equivalent (g/L) | (g/L) | (g/L) | (25° C.) | (mPa · s) |
| A | 1% pectin solution in de- | 13.00 | | | 4.04 | 23 |
| | ionized water | | | | | |
| B | Pectin with SHMP added at | 13.00 | 7.22 | 0.72 | 3.56 | 30 |
| | solution preparation, | | | | | |
| | medium dosage | | | | | |
| C | Pectin with SHMP added at | 13.00 | 7.22 | 1.26 | 3.61 | 31 |
| | solution preparation, high | | | | | |
| | dosage | | | | | |
| D | Pectin with SHMP added | 12.86 | 7.14 | 0.79 | 3.67 | 28 |
| | during manufacturing, | | | | | |
| | medium dosage | | | | | |
| E | Pectin with SHMP added | 12.59 | 6.99 | 1.48 | 3.80 | 26 |
| | during manufacturing, high | | | | | |
| | dosage | | | | | |

TABLE 4b

| Deionized | 1% pectin | Sugar | 17% MSNF | Total | Pectin |
|---|---|---|---|---|---|
| water (g) | solution (g) | (g) | yoghurt (g) | (g) | dosage (%) |
| 449 | 0 | 45 | 106 | 600 | 0.000 |
| 419 | 30 | 45 | 106 | 600 | 0.050 |
| 404 | 45 | 45 | 106 | 600 | 0.075 |
| 389 | 60 | 45 | 106 | 600 | 0.100 |
| 359 | 90 | 45 | 106 | 600 | 0.150 |
| 329 | 120 | 45 | 106 | 600 | 0.200 |
| 299 | 150 | 45 | 106 | 600 | 0.250 |
| 269 | 180 | 45 | 106 | 600 | 0.300 |
| 209 | 240 | 45 | 106 | 600 | 0.400 |
| 149 | 300 | 45 | 106 | 600 | 0.500 |

TABLE 4c

| | Sediments (%) | | | | |
|---|---|---|---|---|---|
| Pectin dosage (%) | A | B | C | D | E |
| 0.000 | 8.52 | 8.52 | 8.52 | 8.52 | 8.52 |
| 0.050 | 9.34 | 9.27 | 9.38 | 8.57 | 7.83 |
| 0.075 | 9.33 | 9.18 | 9.00 | 9.08 | 10.02 |
| 0.100 | 6.47 | 1.71 | 1.61 | 2.02 | 1.76 |
| 0.150 | 1.75 | 1.37 | 1.31 | 1.64 | 1.46 |
| 0.200 | 1.25 | 1.07 | 1.02 | 1.31 | 1.18 |
| 0.250 | 1.01 | 0.88 | 1.27 | 1.37 | 0.86 |
| 0.300 | 1.08 | 0.83 | 1.06 | 1.24 | 0.78 |

TABLE 4d

| | Viscosity (mPa · s) | | | | |
|---|---|---|---|---|---|
| Pectin dosage (%) | A | B | C | D | E |
| 0.000 | | | | | |
| 0.050 | | | | | |
| 0.075 | | | | | |
| 0.100 | 6.50 | 6.00 | 6.00 | 6.00 | 5.50 |
| 0.150 | 6.25 | 6.50 | 6.50 | 6.50 | 6.50 |
| 0.200 | 7.00 | 7.00 | 7.00 | 7.00 | 7.00 |
| 0.250 | 7.50 | 8.00 | 8.50 | 8.25 | 8.00 |
| 0.300 | 8.50 | 9.50 | 10.00 | 9.50 | 9.50 |

All four samples with SHMP appeared on top of each other, and were stronger than the only sample without SHMP, sample A. The addition of SHMP thus enhances the effect of the pectin even when the pectin solution was prepared with de-ionized water. The point at which the SHMP was added, during the pectin manufacturing or the preparation of the pectin solution, made no notable difference in this experiment. The sample without SHMP provided slightly less viscosity; however, when considering the numerical differences and the absence of an estimate of the experimental uncertainty, this conclusion is arguable.

### Example 5

### Test of Sodium Pyrophosphate, CASRN 7758-16-9

Pectin solutions with SHMP and Sodium Pyrophosphate (SPP) were prepared with tap water and de-ionized water according to Table 5a and as described above. Heat-treated prototype milk drinks with diverse concentrations of pectin were prepared by blending 17% MSNF yoghurt and pectin solution according to Table 5b and as described above. A summary of the sediments measured is provided in Table 5c.

TABLE 5a

| | | | | | | | Pectin Solutions | | |
|---|---|---|---|---|---|---|---|---|---|
| | | Weighed out | | | | | Phosphate | | |
| Solution | | Pectin | SHMP | SPP | Sucrose | Total | content | pH | Viscosity |
| Name | Description | (g) | (g) | (g) | (g) | (g) | (% w/w) | (25° C.) | (mPa · s) |
| A | Pectin with 20% | 7.61 | 2.60 | 0 | 2.80 | 13.0 | 20 | 3.44 | 35 |
| | SHMP in de- | | | | | | | | |
| | ionized water | | | | | | | | |
| B | Pectin with 20% | 7.61 | 0.00 | 2.60 | 2.80 | 13.0 | 20 | 3.29 | 37.5 |
| | SPP in de-ionized | | | | | | | | |
| | water | | | | | | | | |
| C | Pectin with 30% | 7.61 | 0.00 | 3.90 | 1.49 | 13.0 | 30 | 3.34 | 39 |
| | SPP in de-ionized | | | | | | | | |
| | water | | | | | | | | |
| D | Pectin with 20% | 7.61 | 0.00 | 2.60 | 2.80 | 13.0 | 20 | 4.08 | 120 |
| | SPP in tap water | | | | | | | | |
| E | Pectin with 30% | 7.61 | 0.00 | 3.90 | 1.49 | 13.0 | 30 | 4.04 | 95 |
| | SHMP in tap | | | | | | | | |
| | water | | | | | | | | |

TABLE 5b

| Deionized | 1% pectin | Sugar | 17% MSNF | Total | Pectin |
|---|---|---|---|---|---|
| water (g) | solution (g) | (g) | yoghurt (g) | (g) | dosage (%) |
| 449 | 0 | 45 | 106 | 600 | 0.000 |
| 419 | 30 | 45 | 106 | 600 | 0.050 |
| 404 | 45 | 45 | 106 | 600 | 0.075 |
| 389 | 60 | 45 | 106 | 600 | 0.100 |
| 359 | 90 | 45 | 106 | 600 | 0.150 |
| 329 | 120 | 45 | 106 | 600 | 0.200 |
| 299 | 150 | 45 | 106 | 600 | 0.250 |
| 269 | 180 | 45 | 106 | 600 | 0.300 |

TABLE 5c

| | Sediments (%) | | | | |
|---|---|---|---|---|---|
| Pectin dosage (%) | A | B | C | D | E |
| 0.000 | 9.02 | 9.02 | 9.02 | 9.02 | 9.02 |
| 0.050 | 10.19 | 9.52 | 9.88 | 7.61 | 8.45 |
| 0.075 | 8.41 | 10.42 | 10.88 | 9.73 | 9.67 |
| 0.100 | 1.40 | 4.20 | 3.73 | 10.05 | 5.64 |
| 0.150 | 1.38 | 1.52 | 1.35 | 1.98 | 1.65 |
| 0.200 | 1.11 | 1.29 | 1.04 | 1.56 | 1.77 |
| 0.250 | 0.99 | 1.19 | 1.00 | 1.35 | 1.61 |
| 0.300 | 1.08 | 0.98 | 1.05 | 1.22 | 1.35 |

The solutions had an apparent ranking of strength of A (strongest)>C≈B>E>D (weakest). Since A was SHMP while B and C were SPP, and they were all dissolved with de-ionized water, it may be concluded that SHMP was the most effective under this circumstance. Since E was better than D, it may be concluded that SPP abated the damaging effect of tap water but was not efficient in this respect as SHMP.

### Example 6

### Way of Adding the SHMP

This experiment was performed in order to assess the influence of the sequence with which the various ingredients may be mixed together. Three yoghurt drinks were made by one operator on the same day and, as far as possible, were identical in all ways except for the following differences:
A. Yoghurt drinks with diverse pectin dosages and no addition of SHMP
B. Yoghurt drinks with diverse pectin dosages, SHMP was added to the yoghurt before adding a pectin solution that did not contain SHMP
C. Yoghurt drinks with diverse pectin dosages, an aqueous solution of pectin and SHMP was prepared and then added to yoghurt
   Powder blends of pectin, sugar and SHMP were prepared as described in Table 6a and then dissolved in deionized water as described above. Heat-treated prototype milk drinks with diverse concentrations of pectin were prepared by blending 17% MSNF yoghurt and pectin solution according to Tables 6b-1, 6b-2, 6b-3 and as described above. A summary of the sediments is provided in Table 6c.

TABLE 6a

| | | Weighed out | | | | Resulting solution | | |
|---|---|---|---|---|---|---|---|---|
| Solution | | Pectin | SHMP | Sucrose | | Pectin | SHMP | Sucrose |
| Name | Description | (g) | (g) | (g) | Total | (%) | (%) | (%) |
| A & C | Pectin standardized | 5.265 | 0.000 | 3.735 | 9.000 | 58.5 | 0.0 | 41.5 |
| | with sucrose in de- | | | | | | | |
| | ionized water | | | | | | | |
| B | Pectin with SHMP and | 5.265 | 1.800 | 1.935 | 9.000 | 58.5 | 20.0 | 21.5 |
| | sucrose in de-ionized | | | | | | | |
| | water | | | | | | | |

*Solutions were made from all blends by dissolving the 9 g in water and increasing the weight up to 900 g with water

TABLE 6b-1

| Deionized | 1% solution | Sugar | 17% MSNF | Total | Stabilizer |
|---|---|---|---|---|---|
| water (g) | blend A&C (g) | (g) | yoghurt (g) | (g) | dosage (%) |
| 449 | 0 | 45 | 106 | 600 | 0.000 |
| 419 | 30 | 45 | 106 | 600 | 0.050 |
| 404 | 45 | 45 | 106 | 600 | 0.075 |
| 389 | 60 | 45 | 106 | 600 | 0.100 |
| 359 | 90 | 45 | 106 | 600 | 0.150 |
| 329 | 120 | 45 | 106 | 600 | 0.200 |
| 299 | 150 | 45 | 106 | 600 | 0.250 |
| 269 | 180 | 45 | 106 | 600 | 0.300 |

TABLE 6b-2

| Deionized | 1% solution | Sugar | 17% MSNF | Total | Stabilizer | | SHMP |
|---|---|---|---|---|---|---|---|
| water (g) | blend B (g) | (g) | yoghurt (g) | (g) | dosage (%) | Pectin (%) | (%) |
| 449 | 0 | 45 | 106 | 600 | 0.000 | 0.000 | 0.0000 |
| 419 | 30 | 45 | 106 | 600 | 0.050 | 0.029 | 0.0100 |
| 404 | 45 | 45 | 106 | 600 | 0.075 | 0.044 | 0.0150 |
| 389 | 60 | 45 | 106 | 600 | 0.100 | 0.059 | 0.0200 |
| 359 | 90 | 45 | 106 | 600 | 0.150 | 0.088 | 0.0300 |
| 329 | 120 | 45 | 106 | 600 | 0.200 | 0.117 | 0.0400 |
| 299 | 150 | 45 | 106 | 600 | 0.250 | 0.146 | 0.0500 |
| 269 | 180 | 45 | 106 | 600 | 0.300 | 0.176 | 0.0600 |

TABLE 6b-3

| | 1% | | 17% | | | | | |
|---|---|---|---|---|---|---|---|---|
| | solution | | MSNF | SMHP to | | Stabilizer | | |
| Deionized | blend | Sugar | yoghurt | yoghurt | Total | dosage | Pectin | SHMP |
| water (g) | A&C (g) | (g) | (g) | (g) | (g) | (%) | (%) | (%) |
| 449 | 0 | 45 | 106 | 0 | 600.00 | 0.000 | 0.000 | 0.0000 |
| 419 | 30 | 45 | 106 | 0.06 | 600.06 | 0.050 | 0.029 | 0.0100 |
| 404 | 45 | 45 | 106 | 0.09 | 600.09 | 0.075 | 0.044 | 0.0150 |
| 389 | 60 | 45 | 106 | 0.12 | 600.12 | 0.100 | 0.058 | 0.0200 |
| 359 | 90 | 45 | 106 | 0.18 | 600.18 | 0.150 | 0.088 | 0.0300 |
| 329 | 120 | 45 | 106 | 0.24 | 600.24 | 0.200 | 0.117 | 0.0400 |
| 299 | 150 | 45 | 106 | 0.3 | 600.30 | 0.250 | 0.146 | 0.0500 |
| 269 | 180 | 45 | 106 | 0.36 | 600.36 | 0.300 | 0.175 | 0.0600 |

TABLE 6c

| | Sediments (%) | | |
|---|---|---|---|
| Pectin dosage (%) | A | B | C |
| 0.000 | 7.84 | 7.84 | 7.84 |
| 0.050 | 8.88 | 7.43 | 8.29 |
| 0.075 | 9.60 | 9.66 | 9.85 |
| 0.100 | 9.79 | 2.28 | 7.65 |
| 0.150 | 2.77 | 1.36 | 1.30 |
| 0.200 | 1.62 | 1.13 | 1.26 |
| 0.250 | 1.36 | 1.02 | 1.01 |
| 0.300 | 1.58 | 1.01 | 1.02 |

The strength of the samples ranked from (strongest) B>C>A (weakest), at least when looking to the lowest dosage that provided a sediment of less than 2.5%. It could be argued, however, that the ranking was disputable because curve B was not to the lower left of curve C within their entire range of dosages. Accepting the above suggested ranking, however, addition of SHMP to the yoghurt prior to dosing a pectin solution (without SHMP) provided better stability than when SHMP was not added. However, the SHMP seemingly worked more effectively when it was added together with the pectin in an aqueous solution with the two materials together.

While the invention has been described in detail with respect to specific embodiments thereof, it will be appreciated that those skilled in the art, upon attaining an understanding of the foregoing, may readily conceive of alterations to, variations of, and equivalents to these embodiments. Accordingly, the scope of the present invention should be assessed as that of the appended claims and any equivalents thereof.

1. A process for preparing an acidified milk drink comprising the steps of:
providing an acidified milk product comprising a fluid suspension of protein and dissolved calcium salts;
preparing an aqueous stabilizer solution comprising an HM pectin and one or more sequestrants; and thereafter
blending the aqueous stabilizer solution and the acidified milk product to provide an acidified milk drink,
wherein the acidified milk drink is characterized as a stable, optically opaque, drinkable product.

2. The process of claim 1, wherein the acidified milk drink has a pH from about 3.0 to about 5.0.

3. The process of claim 1, wherein the protein comprises a dairy-based protein, plant-based protein, or combination thereof.

4. The process of claim 1, wherein the HM pectin has a degree of methyl-esterification of greater than about 50.

5. The process of claim 1, wherein the HM pectin has a degree of methyl-esterification from about 55 to about 85.

6. The process of claim 1, wherein the HM pectin is a non-amidated pectin derived from a citrus peel.

7. The process of claim 6, wherein the HM pectin has a degree of methyl-esterification from about 59 to about 77.

8. The process of claim 1, wherein the HM pectin is present in the acidified milk drink at a concentration from about 0.05 to about 0.5% (w/w).

9. The process of claim 1, wherein the one or more sequestrants comprise sodium hexa-meta phosphate, sodium pyrophosphate, or a combination thereof.

10. The process of claim 1, wherein the one or more sequestrants are present in the aqueous stabilizer solution in an amount that is stoichiometrically greater than a concentration of calcium ions present in the aqueous stabilizer solution and are present in the acidified milk drink in an amount that is stoichiometrically less than a concentration of calcium ions in the acidified milk drink.

11. The process of claim 10, wherein the one or more sequestrants are present in the aqueous stabilizer solution in a concentration from about 1 to about 20% (w/w) and are present in the acidified milk drink in a concentration from about 0.001 to about 1.0% (w/w).

12. The process of claim 10, wherein the one or more sequestrants are present in the aqueous stabilizer solution in a concentration from about 5 to about 20% (w/w) and are present in the acidified milk drink in a concentration from about 0.001 to about 0.5% (w/w).

13. The process of claim 10, wherein the one or more sequestrants are present in the aqueous stabilizer solution in a concentration from about 10 to about 20% (w/w) and are present in the acidified milk drink in a concentration from about 0.005 to about 0.1% (w/w).

14. The process of claim 1, wherein preparing an aqueous stabilizer solution comprises dry-blending the HM pectin and the one or more sequestrants and thereafter dissolving the dry-blend in an aqueous media.

15. The process of claim 1, wherein preparing an aqueous stabilizer solution comprises adding the HM pectin to an aqueous solution comprising the one or more sequestrants.

16. The process of claim 1, wherein the aqueous stabilizer solution is prepared using de-ionized water, tap water, or a combination thereof.

17. The process of claim 1, wherein the acidified milk drink comprises a drinkable yoghurt.

18. An acidified milk drink characterized as a stable, optically opaque, drinkable product comprising an acidified milk product, an HM pectin, and one or more sequestrants, and having a pH from about 3.0 to about 5.0, wherein:
the HM pectin has a degree of methyl-esterification from about 55 to about 85 and is present in the acidified milk drink at a concentration from about 0.05 to about 0.5% (w/w), and
the one or more sequestrants are present in the acidified milk drink at a concentration from about 0.001 to about 0.5% (w/w).

19. The acidified milk drink of claim 18, wherein the HM pectin is present in the acidified milk drink at a concentration from about 0.05 to about 0.15% (w/w) and the one or more sequestrants are present in the acidified milk drink at a concentration from about 0.001 to about 0.1% (w/w).

20. The acidified milk drink of claim 18, wherein the stable, optically opaque, drinkable product is characterized by having less than about 2.5% sediment.
